(19) United States
(12) Patent Application Publication
(10) Pub. No.: US 2013/0067784 A1
(43) Pub. Date: Mar. 21, 2013

(54) Sign Assembly

(71) Applicant: Richard Paul Parker, Prospect, KY (US)

(72) Inventor: Richard Paul Parker, Prospect, KY (US)

(21) Appl. No.: 13/621,840

(22) Filed: Sep. 17, 2012

Related U.S. Application Data
(60) Provisional application No. 61/536,125, filed on Sep. 19, 2011.

(51) Int. Cl. G09F 15/02; B23P 11/00

(52) U.S. Cl. 40/607.03; 29/428

(57) ABSTRACT

A sign assembly according to one example embodiment includes a plurality of support poles having a generally elongated pole body. Each support pole has a first end that includes a tapered portion for insertion into a support medium. The sign assembly further includes a sign portion having a plurality of sleeves formed therein. Each sleeve is shaped to receive a respective one of the plurality of support poles. Each sleeve is open at a first end to receive the respective support pole and closed at a second end opposite the first end to retain the sign portion on the support poles when the support poles are inserted into the sleeves in order to removably attach the sign portion to the support poles such that the support poles physically support the sign portion.

### CROSS-REFERENCE TO RELATED APPLICATIONS

This application claims priority to U.S. Provisional Application No. 61/536,125, entitled “Sign Assembly” and filed on Sep. 19, 2011, which is incorporated by reference herein in its entirety.

### BACKGROUND

The present invention relates generally to a sign assembly and more particularly to a sign assembly that includes a plurality of support poles and a sign portion that removably attaches thereto.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is a perspective view of a sign assembly according to one example embodiment.

FIG. 2 is a perspective view of a support pole according to one example embodiment.

FIG. 3 is an exploded perspective view of a support pole according to one example embodiment.

FIG. 3a is a perspective view of a support pole having an angled tip according to one example embodiment.

FIG. 3b is a perspective view of a support pole having a flat tip according to one example embodiment.

FIG. 3c is a perspective view of a support pole having a rounded tip according to one example embodiment.

FIG. 4 is a cross-sectional view of a support pole receiving a driving force according to one example embodiment.

FIG. 5 is an exploded view of a pair of support poles and a sign portion forming a sign assembly according to one example embodiment.

FIG. 6 is a perspective view of a sheet of flexible, thin, plastic film forming a sign portion according to one example embodiment.

FIG. 7 is a close up front elevation view of a corner of the sign portion shown in FIG. 5 illustrating a sleeve formed therein for receiving a corresponding support pole according to one example embodiment.

FIG. 8 is a front elevation view of a sign assembly that includes a sign portion formed by two sheets joined together according to one example embodiment.

FIG. 9 is a front elevation view of sign assembly that includes a sign portion formed by a sheet of material having a pair of patches joined thereto that form a corresponding pair of sleeves according to one example embodiment.

FIG. 10 is a front elevation view of a sign assembly that includes a sign portion having an intermediate sleeve that receives an additional support pole therein according to one example embodiment.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense and the scope of the present invention is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

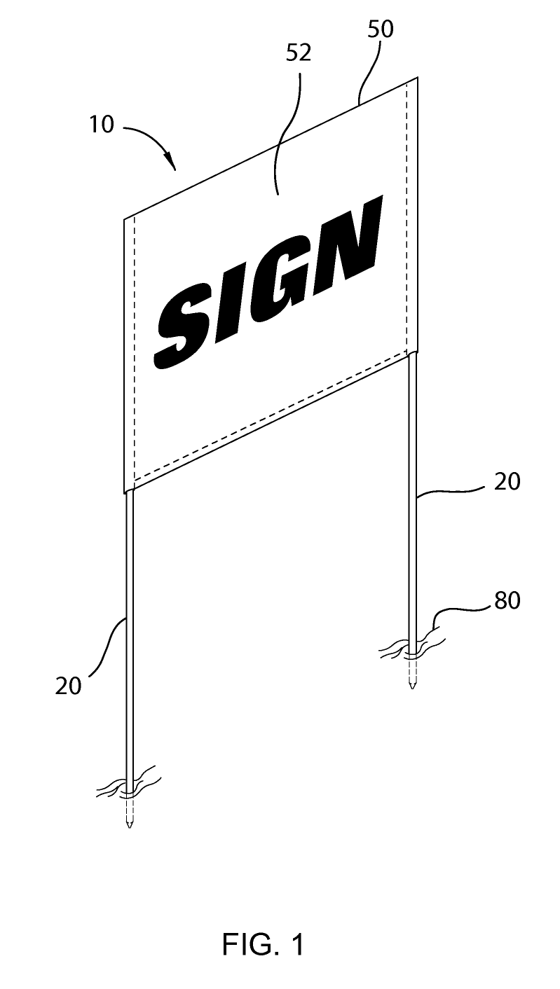

FIG. 1 shows an example embodiment of a sign assembly 10. Sign assembly 10 includes a plurality of support poles 20 and a sign portion 50. Sign assembly 10 is formed by attaching sign portion 50 to support poles 20 as described in greater detail below. Sign portion 50 includes a display 52 thereon. Display 52 may include text, one or more images, one or more patterns, or a combination thereof. In the example embodiment illustrated, display 52 includes text that reads “SIGN.” A portion of each support pole 20 is inserted into a support medium 80 such as, for example, the ground in order to physically support sign assembly 10 in a substantially upright position.

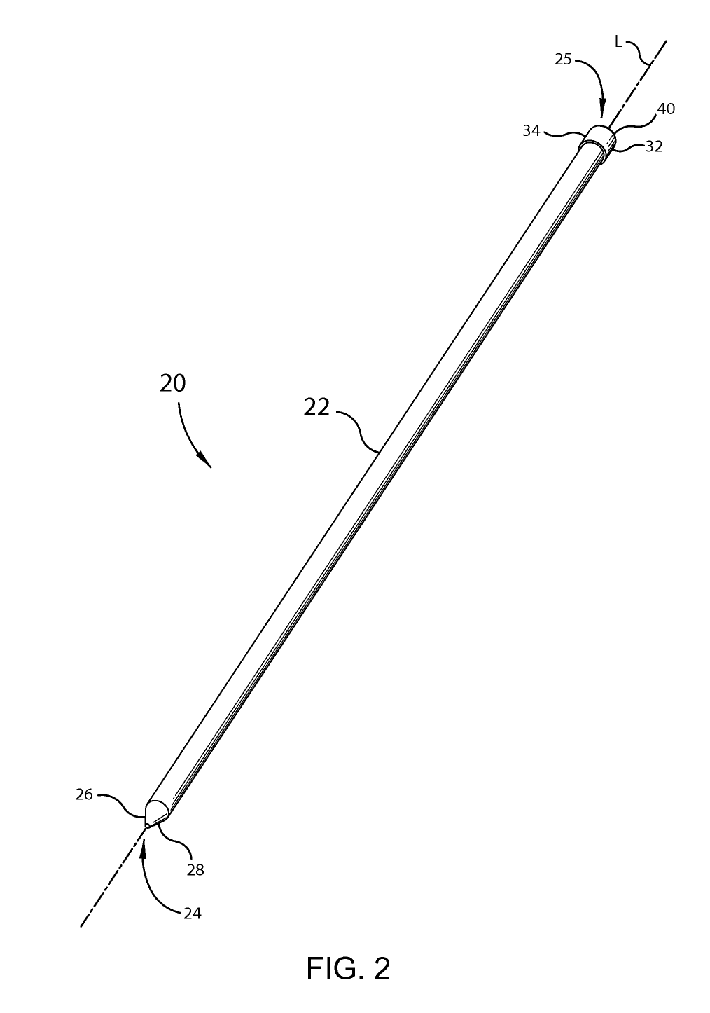

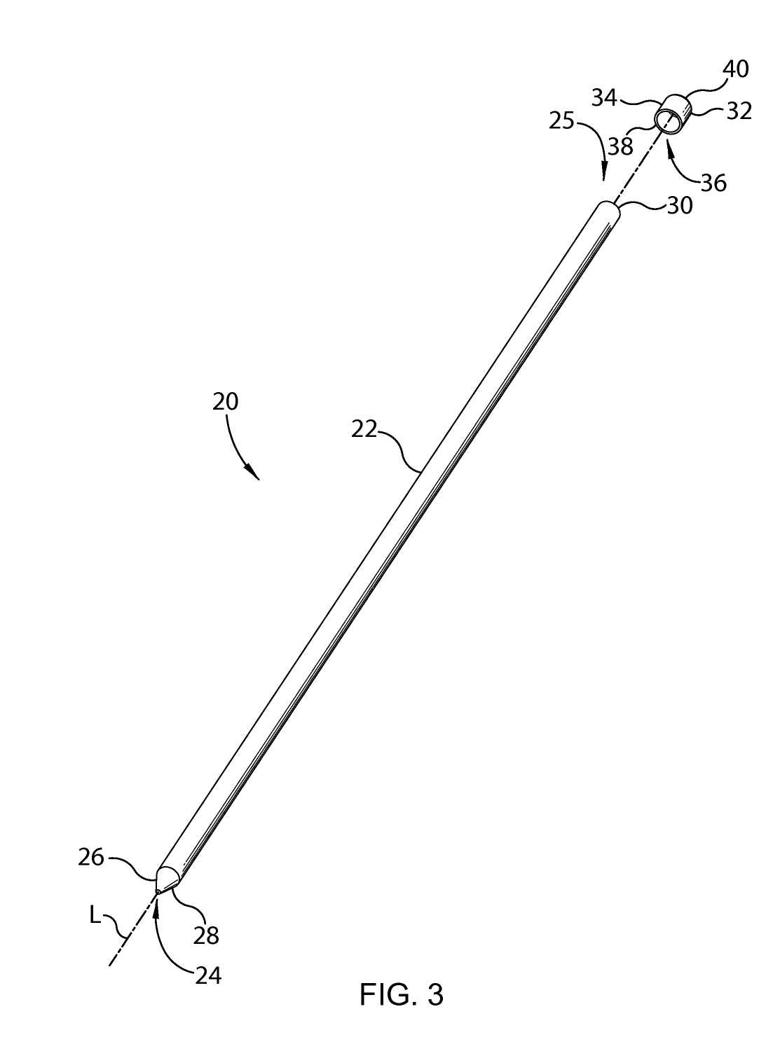

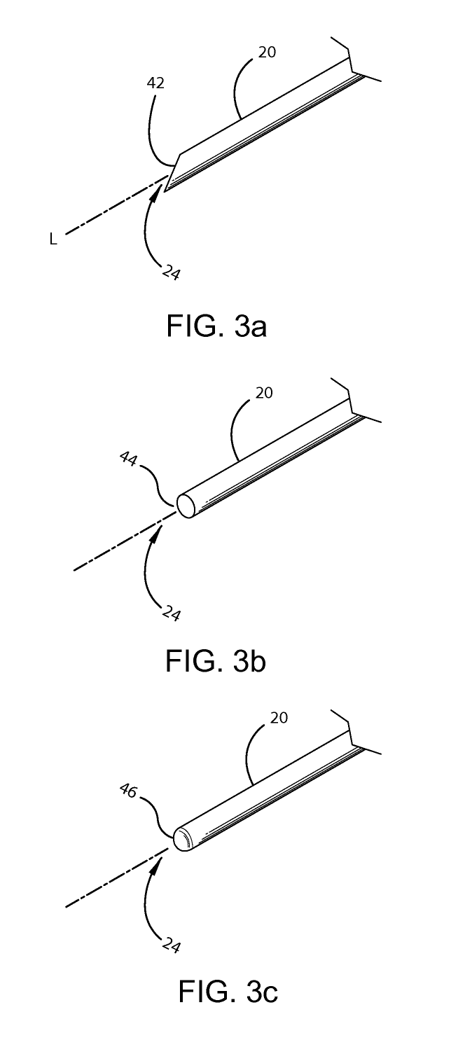

With reference to FIGS. 2 and 3, support poles 20 include a generally elongated pole body 22. Pole body 22 may be formed from fiberglass, plastic or other lightweight, resilient and weather-resistant material extending along a longitudinal axis L thereof. The material composition of pole body 22 provides the shock transmission necessary to efficiently allow a user to drive support pole 20 into the ground. The material composition of pole body 22 also provides durability and facilitates repeated and continued use of support poles 20 year after year.

Pole body 22 includes a first end 24 and a second end 25. In the example embodiment illustrated in FIGS. 2 and 3, first end 24 is defined by a tapered portion 26 having generally conical walls 28 for insertion into support medium 80. In some embodiments, tapered portion 26 ends in a pointed tip. Alternatives include those wherein tapered portion 26 reduces to a generally flat end surface having a radius less than the radius of pole body 22. Pole body 22 extends along the generally longitudinal axis L thereof. This configuration allows for reversible and removable insertion of support pole 20 into support medium 80. Tapered portion 26 provides a small pressure surface for ground contact to enhance the ability of a user to force support pole 20 into support medium 80. The configuration of tapered portion 26 allows for ease of repeated driving insertion into support medium 80. In some embodiments, the slope of tapered portion 26 forms an angle of greater than forty-five degrees from the centerline longitudinal axis L of pole body 22. The relative bluntness of support pole 20 piles up dirt ahead of support pole 20 more rapidly than a more gradual taper and therefore helps to prevent over-insertion of support pole 20. In some embodiments, second end 25 of pole body 22 includes a generally flat upper surface 30. Alternatives include those wherein upper surface 30 of second end 25 is formed with a rough surface such as may be left by a saw or machine cut. In one example embodiment, the diameter of pole body 22 is between about one-quarter inch and about one-half inch. The length of each support pole 20 is dictated by the requirements of sign assembly 10; however, in one example embodiment, the length of each support pole 20 is between about 3 feet and about 4 feet. Accordingly, support poles 20 may be driven relatively deep into the ground such as, for example 1 foot to 2 feet into the ground in order to provide maximum support for sign assembly 10.

It will be appreciated that although tapered portion 26 shown in FIGS. 2 and 3 enhances the ability of a user to force support pole 20 into support medium 80, first end 24 of support pole 20 may have any suitable shape. For example, first end 24 may include an angled tip 42 cut at an angle to longitudinal axis L of support pole 20 (FIG. 3a), a flat tip 44 (FIG. 3b), or a rounded tip 46 (FIG. 3c).

With reference back to FIGS. 2 and 3, in the example embodiment illustrated, support pole 20 includes an impact cap 32 disposed at second end 25 of pole body 22. Impact cap 32 includes a cylindrical wall 34. A nail-head surface 40, comprising a generally flat end panel, is formed integrally with cylindrical wall 34 to ultimately form impact cap 32. Some embodiments of nail-head surface 40 have a substantially planar surface. Nail-head surface 40 and cylindrical wall 34 define an internal cavity 36 having an access opening 38 into which second end 25 of pole body 22 projects. Impact cap 32 includes a substantially planar surface opposing access opening 38. Embodiments include those wherein access opening 38 provides access to internal cavity 36 of cylindrical walls 34. As desired, the diameter of internal cavity 36 is selected to be slightly larger than the diameter of pole body 22 such that second end 25 of pole body 22 fits snugly within internal cavity 36. In some embodiments, impact cap 32 is fitted over second end 25 of pole body 22 in a snug, friction-fitting manner. In some embodiments, the planar surface of impact cap 32 opposing access opening 38 is in substantial contact with upper surface 30 of second end 25 of pole body 22 when impact cap 32 is fitted over second end 25 of pole body 22. Impact cap 32 allows the user to drive support pole 20 into the ground by applying force directly to impact cap 32. In some embodiments, impact cap 32 is generally undeformable and generally unbreakable thereby providing durability and facilitating repeated and continued use of support pole 20 year after year.

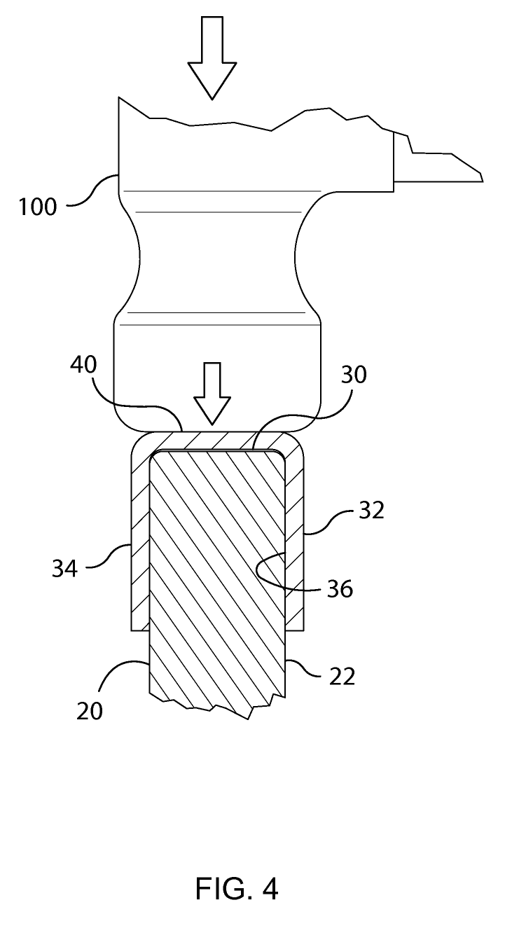

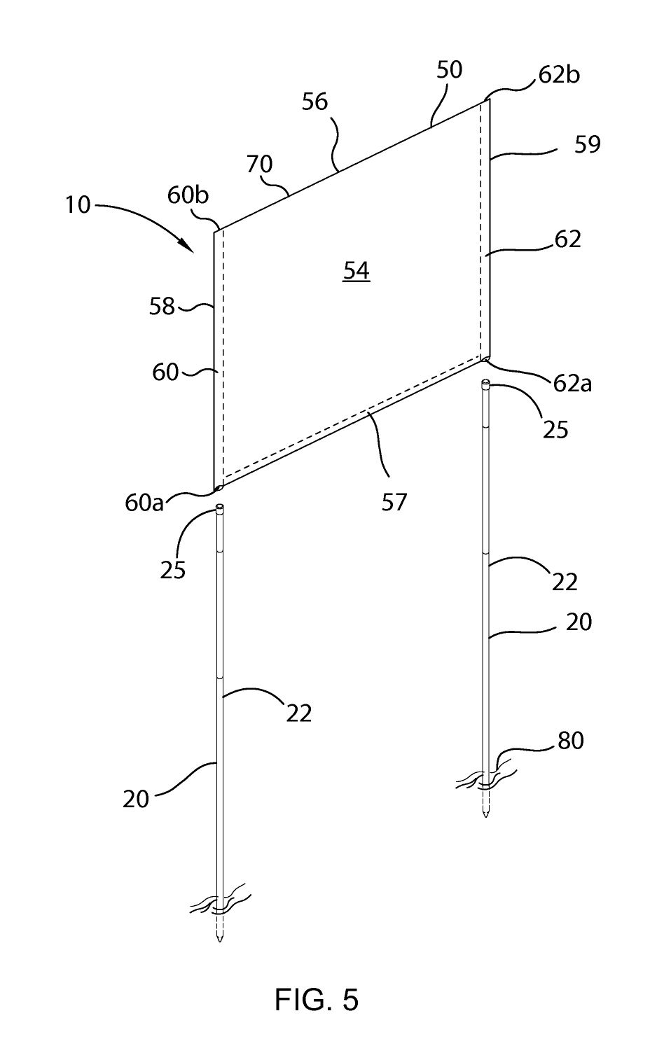

With reference to FIG. 4, providing nail-head surface 40 in combination with cylindrical wall portion 34 forms an effective impact structure to receive blows from a driving implement 100 such as, for example, a hammer, and to distribute the resultant forces effectively. As shown, impact cap 32 has a generally cylindrical profile. The impact force is substantially evenly transmitted to support pole 20. Upon receiving impact force from driving implement 100, impact cap 32 distributes the impact force evenly over support pole 20, thereby achieving enhanced efficiency and reduced force transmission sequentially from driving implement 100, to flat nail head surface 40 of impact cap 32, to the planar surface of impact cap 32, and to upper surface 30 of second end 25 of pole body 22 during reversible and removable insertion of support pole 20 into support medium 80.

In operation, a user may take a hammer or other driving implement 100 to impact cap 32 to drive support pole 20 into support medium 80. In some embodiments, one or two blows are sufficient to drive support pole 20 sufficiently into the ground. Impact cap 32 provides the ability to drive support pole 20 into support medium 80 to the extent that it will be able to support sign portion 50 and will typically not blow over. Further, in some embodiments, impact cap 32 prevents upper surface 30 of second end 25 of pole body 22 from splintering, mushrooming or deforming upon receiving force from a driving implement. Alternatives include those wherein an impact cap 32 is not provided on second end 25 of support pole 20.

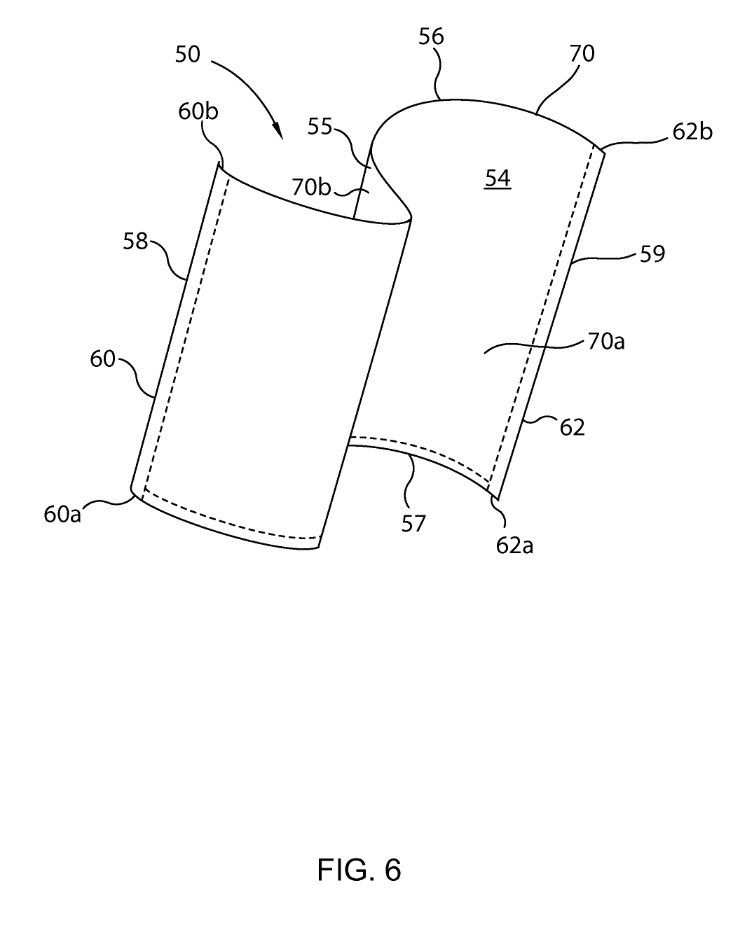

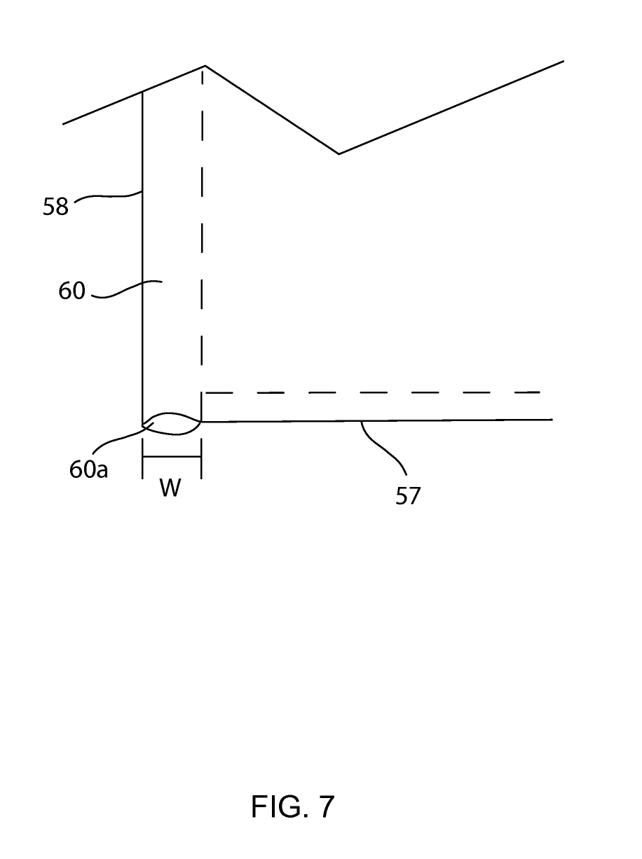

With reference to FIGS. 5-7, sign portion 50 includes a front face 54 and a rear face 55 formed between a top edge 56, a bottom edge 57 and two side edges 58, 59. In the example embodiment illustrated, front face 54 and rear face 55 are rectangular in shape; however, any suitable shape may be used as desired including, but not limited to, square shaped, circular, oval, triangular, hexagonal, octagonal, or an irregular shape. As illustrated in FIG. 6, sign portion 50 is composed of a thin, flexible, plastic film such as, for example a polyethylene film. Alternatives include cloth, fabric, or various textiles. The flexible nature of sign portion 50 allows it to be rolled for convenient storage.

Sign portion 50 includes a pair of sleeves 60, 62 formed as an opening or pocket therein. Each sleeve 60, 62 includes an open end 60a, 62a and a closed end 60b, 62b opposite open end 60a, 62a. Open ends 60a, 62a may be formed along bottom edge 57 or spaced inward from bottom edge 57 as desired. In one embodiment, closed ends 60b, 62b are formed along top edge 56. This particular arrangement is especially advantageous where sign portion 50 is formed from an especially flexible material, such as a thin, plastic film. Otherwise top edge 56 of sign portion 50 would tend to drape downward with gravity possibly obscuring an upper portion of display 52. However, where sign portion 50 is formed from a more rigid material, such as paper or posterboard, closed ends 60b, 62b may be spaced slightly downward from top edge 56 depending on the beam strength of the material used. In one embodiment, sleeves 60, 62 are formed at opposite side edges 58, 59, respectively, of sign portion 50. Again, this particular arrangement is especially advantageous where sign portion 50 is formed from an especially flexible material, such as thin, plastic film. Otherwise the sides of sign portion 50 extending outward from sleeves 60, 62 would tend to drape downward with gravity thereby obscuring any portion of display 52 thereon. However, where sign portion 50 is formed from a more rigid material, such as paper or posterboard, sleeves 60, 62 may be spaced inward from side edges 58, 59, respectively, as desired.

Sleeves 60, 62 are each sized to receive a corresponding support pole 20 therein. Specifically, sleeves 60, 62 are substantially straight, elongated pockets shaped to accommodate support poles 20. The openings or pockets formed by sleeves 60, 62 have a width W that is greater than the largest diameter of support poles 20 so that a support pole 20 will fit within each sleeve 60, 62. However, width W is small enough to limit the lateral freedom of poles 20 in sleeves 60, 62 in order to prevent excessive lateral movement of poles 20 that could result in imprecise positioning of sign portion 50 on support poles 20.

In the example embodiment illustrated in FIGS. 5-7, sign portion 50 is composed of a single sheet 70 of flexible, thin, plastic film. In this embodiment, top edge 56 and side edges 58, 59 are formed by folds between a first portion 70a and a second portion 70b of sheet 70 like a plastic bag. This construction may be formed using conventional methods known in the art such as a blown film extrusion process. Front face 54 is formed on first portion 70a of sheet 70 and rear face 55 is formed on second portion 70b of sheet 70. Alternatively, instead of being formed by a fold, side edges 58, 59 may be joined together such as by heat sealing first portion 70a of sheet 70 to second portion 70b of sheet 70. Further, as an alternative to heat sealing, portions 70a, 70b may be joined by an adhesive or by being woven together along side edges 58, 59.

In the example embodiment illustrated, portions 70a, 70b are heat sealed together along bottom edge 57 (indicated by a dashed line) such that open ends 60a, 62a of sleeves 60, 62 are the only openings in the perimeter of sign portion 50. This prevents wind and debris from reaching the interior of sign portion 50 and disrupting the positioning of sign portion 50. However, bottom edge 57 may be left unsealed as desired. Sleeves 60, 62 are formed between portions 70a, 70b by heat seal (indicated by dashed lines). As discussed above, an adhesive or weave may be used as an alternative to heat sealing as desired.

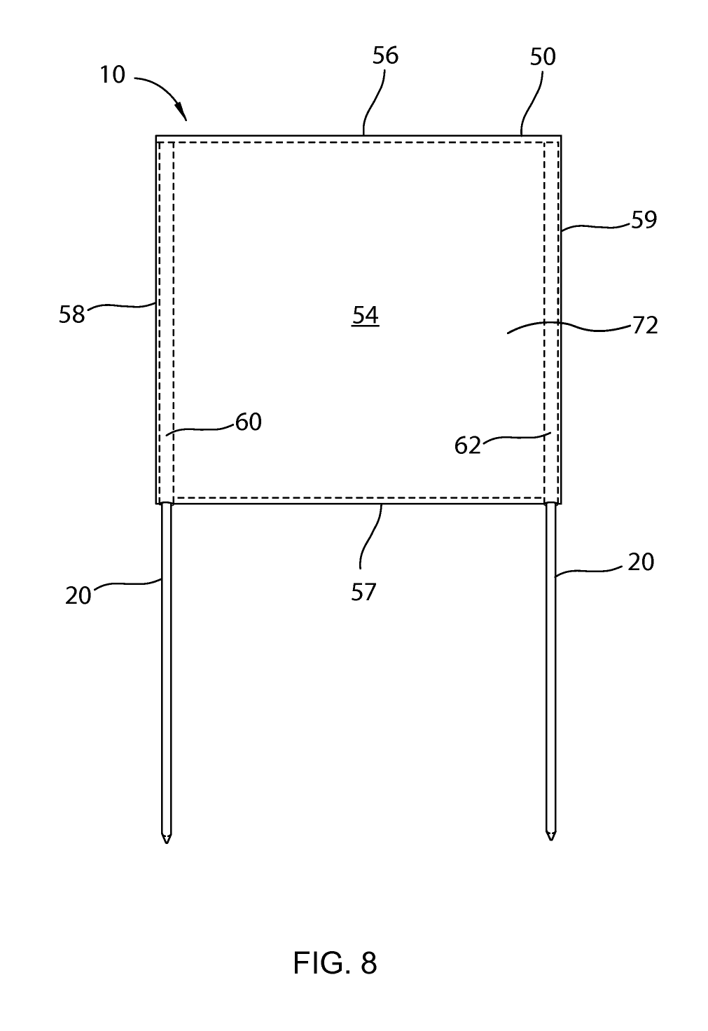

With reference to FIG. 8, an alternative embodiment is shown wherein sign portion 50 is formed by two sheets of flexible, thin, plastic film joined together, such as by heat sealing, along top edge 56, side edges 58, 59 and optionally along bottom edge 57. FIG. 8 shows a first sheet 72; the second sheet (not shown) is heat sealed to first sheet 72 along the dashed lines shown. In this configuration, front face 54 is formed on one sheet 72 and rear face 55 is formed on the other sheet. Sleeves 60, 62 are formed between the sheets by additional heat sealing. As discussed above, an adhesive or weave may be used as an alternative to heat sealing as desired.

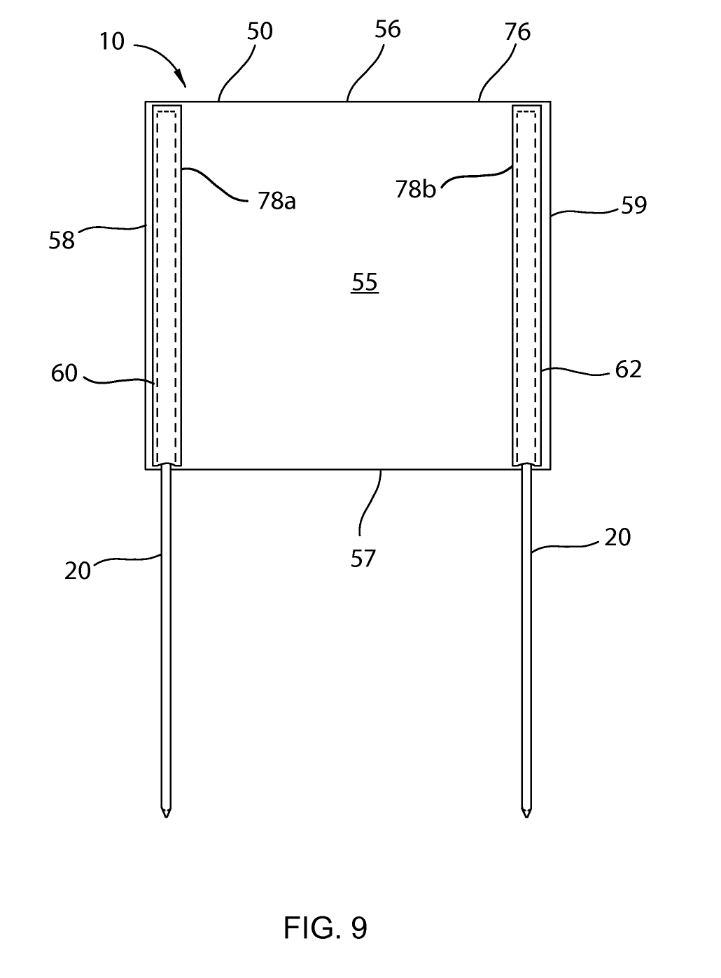

With reference to FIG. 9, another alternative embodiment is shown wherein sign portion 50 is formed by a single sheet 76 of flexible, thin, plastic film. In this embodiment, front face 54 and rear face 55 are formed on opposite sides of a common sheet 76. Top edge 56, bottom 57 and side edges 58, 59 simply comprise the respective edges of sheet 76. Sleeves 60, 62 are formed between either front face 54 or rear face 55 of sheet 76 and an additional patch of material 78a, 78b placed near each side edge 58, 59. Patches 78a, 78b may be joined to sheet 76 by heat sealing, adhesive, by weaving the materials together, etc., as discussed above. Alternatively, sleeves 60, 62 may be formed in sheet 76 by folding sheet 76 over itself along side edge 58, 59 and joining an edge of sheet 76 to front face 54 or rear face 55.

With reference back to FIG. 5, to assemble sign assembly 10, the second end 25 of each support pole 20 is first inserted into the open end 60a, 62a of its corresponding sleeve 60, 62. The pole body 22 of each support pole 20 is then slid within the corresponding sleeve 60, 62 from its open end 60a, 62a until the second end 25 of the support pole 20 contacts closed end 60b, 62b of its corresponding sleeve 60, 62. Stated differently, after the second end 25 of each support pole 20 is inserted into sleeves 60, 62, sign portion 50 is slid along pole bodies 22 and onto support poles 20. Closed ends 60b, 62b prevent support poles 20 from passing through top edge 56 of sign portion 50 and serve to retain sign portion 50 on support poles 20 when sign assembly 10 is positioned in a vertical orientation. In this manner, support poles 20 provide physical support for sign portion 50 in order to facilitate the display of display 52.

Support poles 20 may be inserted into support medium 80 either before or after sign portion 50 is attached thereto. In one embodiment, it is preferable to insert support poles 20 into support medium 80 prior to attaching sign portion 50 so that an impact tool, such as a hammer, may be used to drive supports poles 20 into support medium 80 without tearing or damaging sign portion 50. It will be appreciated that sleeves 60, 62 facilitate removable attachment of sign portion 50 to support poles 20. In order to disassemble sign assembly 10, a user simply slides sign portion 50 off of support poles 20. In other words, a user may disassemble sign assembly 10 simply by sliding support poles 20 out of sleeves 60, 62 of sign portion 50.

Because bodies 22 of support poles 20 are formed from fiberglass, plastic or other lightweight, resilient and weather-resistant materials, support poles 20 are able to physically support sign portion 50 thereon while withstanding stresses from external forces such as wind or passing people, animals or objects. Support poles 20 are also less likely to tear or poke through closed ends 60b, 62b when support poles 20 are inserted into sleeves 60, 62 than conventional steel or wood posts. The weather-resistant characteristics of these materials permit repeated use of sign assembly 10 for relatively long durations.

It is preferred that support poles 20 are inserted in support medium 80 such that the separation between them is substantially equal to the separation between sleeves 60, 62. If support poles 20 are placed too close together, when sign portion 50 is attached thereto, it will appear wrinkled or bunched. Conversely, if support poles 20 are placed too far apart, it may be impossible to attach sign portion 50 thereto or sign portion 50 may become stretched or torn. It will be appreciated that positioning support poles 20 at a separation distance that is substantially equal to the distance between sleeves 60, 62 improves the aesthetic appearance of display 52.

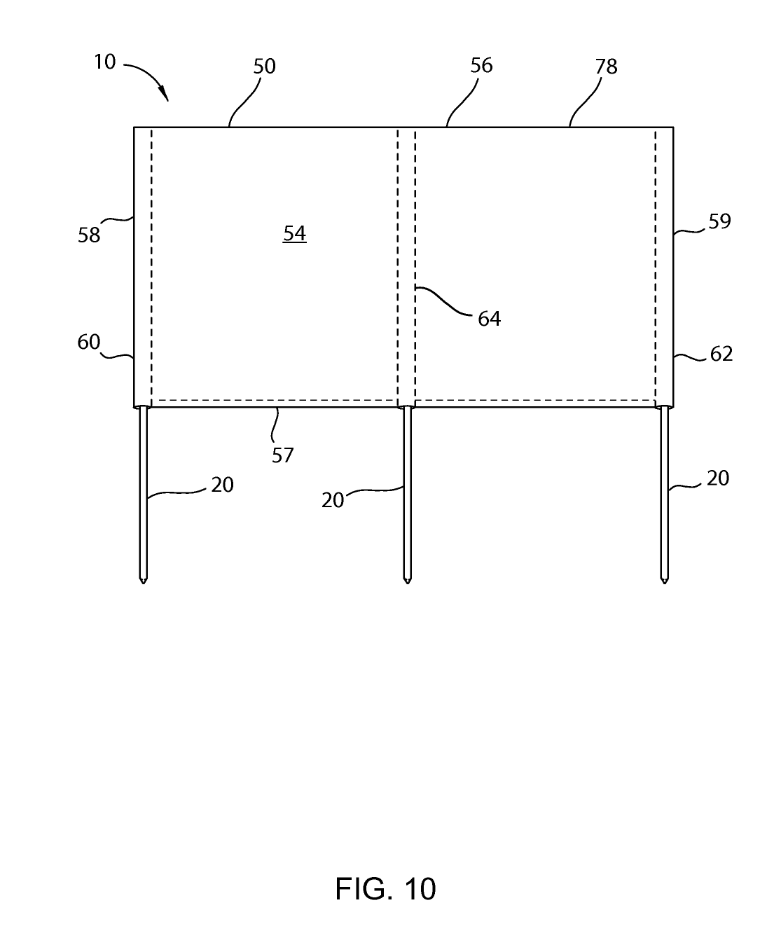

With reference to FIG. 10, where a wider, banner-type sign portion 50 is desired, more than two sleeves 60, 62 and corresponding poles 20 may be used in order to provide additional structural support for sign portion 50. In this embodiment, two sleeves 60, 62 are positioned near side edges 58, 59, respectively, as discussed above and one or more additional sleeve(s) 64 are positioned therebetween. Additional sleeve(s) 64 assist in preventing the weight of sign portion 50 from pulling or dragging a center region of sign portion 50 down toward support medium 80 due to gravity in order to improve the presentation of display 52.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

What is claimed is:

1. A sign assembly, comprising:
a plurality of support poles having a generally elongated pole body, each support pole having a first end that includes a tapered portion for insertion into a support medium; and
a sign portion having a plurality of sleeves formed therein each shaped to receive a respective one of the plurality of support poles, each sleeve being open at a first end for receiving the respective support pole and closed at a second end opposite the first end to retain the sign portion on the support poles when the support poles are inserted into the sleeves in order to removably attach the sign portion to the support poles such that the support poles physically support the sign portion.

2. The sign assembly of claim 1, wherein at least one of the support poles includes an impact cap with a flat nail-head surface attached to a second end of the support pole opposite the first end for receiving a driving force to drive the support pole into the support medium.

3. The sign assembly of claim 2, wherein the impact cap has a generally cylindrical body having an access opening correspondingly formed to receive the second end of the support pole, the impact cap being fitted over the pole body.

4. The sign assembly of claim 3, wherein the impact cap includes a substantially planar interior surface opposing the access opening and the second end of the support pole includes a substantially planar upper surface abutting the substantially planar interior surface of the impact cap.

5. The sign assembly of claim 1, wherein at least one of the support poles is made from a lightweight, weather-resistant material.

6. The sign assembly of claim 1, wherein the sign portion has a top edge, a bottom edge, and a plurality of side edges.

7. The sign assembly of claim 6, wherein the sign portion has a front face formed between the top edge, bottom edge, and side edges and a rear face formed between the top edge, bottom edge, and side edges.

8. The sign assembly of claim 6, wherein at least one of the sleeves is formed at one of the side edges of the sign portion.

9. The sign assembly of claim 6, wherein the first ends of the sleeves are formed along the bottom edge of the sign portion to receive the support poles at the bottom edge of the sign portion.

10. The sign assembly of claim 6, wherein the second ends of the sleeves are formed along the top edge of the sign portion.

11. The sign assembly of claim 1, wherein the sign portion is made from a flexible film.

12. A sign assembly, comprising:
a plurality of support poles having a generally elongated pole body, each support pole having a first end that includes a tapered portion for insertion into a support medium; and
a sign portion having a plurality of sleeves formed therein each shaped to receive a respective one of the plurality of support poles, each sleeve being open at a first end for receiving the respective support pole and closed at a second end opposite the first end to retain the sign portion on the support poles when the support poles are inserted into the sleeves in order to removably attach the sign portion to the support poles such that the support poles physically support the sign portion,
wherein the first ends of the sleeves are formed along a bottom edge of the sign portion to receive the support poles at the bottom edge of the sign portion and the second ends of the sleeves are formed along a top edge of the sign portion.

13. The sign assembly of claim 12, wherein at least one of the support poles includes an impact cap with a flat nail-head surface attached to a second end of the support pole opposite the first end for receiving a driving force to drive the support pole into the support medium.

14. The sign assembly of claim 13, wherein the impact cap has a generally cylindrical body having an access opening correspondingly formed to receive the second end of the support pole, the impact cap being fitted over the pole body.

15. The sign assembly of claim 14, wherein the impact cap includes a substantially planar interior surface opposing the access opening and the second end of the support pole includes a substantially planar upper surface abutting the substantially planar interior surface of the impact cap.

16. The sign assembly of claim 12, wherein the sign portion has a plurality of side edges and at least one of the sleeves is formed at one of the side edges of the sign portion.

17. A method for providing a sign assembly, comprising:
attaching a sign portion to a plurality of support poles using a plurality of sleeves formed within the sign portion by:
inserting an end of a first support pole into an open end of a first sleeve;
sliding the first support pole within the first sleeve until the end of the first support pole reaches a closed end of the first sleeve;
inserting an end of a second support pole into an open end of a second sleeve; and
sliding the second support pole within the second sleeve until the end of the second support pole reaches a closed end of the second sleeve.

18. The method of claim 17, further comprising inserting a tapered end portion of at least one of the support poles into a support medium for supporting the sign assembly.

19. The method of claim 18, wherein inserting the tapered end portion into the support medium is performed before attaching the sign portion to the support poles.

20. The method of claim 17, further comprising positioning the first support pole and the second support pole at a separation distance substantially equal to the distance between the first sleeve and the second sleeve.
